(19) United States
(12) Patent Application Publication
(10) Pub. No.: US 2024/0120762 A1
(43) Pub. Date: Apr. 11, 2024

(54) CONTROL DEVICE FOR ENERGY STORAGE CELL, ENERGY STORAGE APPARATUS, CHARGING SYSTEM, AND METHOD FOR CONTROLLING CHARGE VOLTAGE

(71) Applicant: GS Yuasa International Ltd., Kyoto (JP)

(72) Inventors: Satoru NARIMOTO, Kyoto (JP); Atsushi FUKUSHIMA, Kyoto (JP); Yuki IMANAKA, Kyoto (JP)

(21) Appl. No.: 18/546,144

(22) PCT Filed: Feb. 25, 2022
(86) PCT No.: PCT/JP2022/007781

§ 371 Date: Aug. 11, 2023

(30) Foreign Application Priority Data
Mar. 1, 2021 (JP) 2021-031472

(51) Int. Cl. H02J 7/00; H01M 10/44; H01M 10/46

(52) U.S. Cl. CPC H02J 7/00712; H01M 10/44; H01M 10/46; H02J 7/00032; H02J 7/0048; B60R 16/033

(57) ABSTRACT

A control device 120 of an energy storage cell 62 calculates an SOC or a remaining charge of the energy storage cell 62 by a current integration method, and determines a command value of a charge voltage for the energy storage cell based on the SOC or the remaining charge obtained by the current integration method.

### CROSS REFERENCE TO RELATED APPLICATIONS

This application is a National Stage Application, filed under 35 U.S.C. § 371, of International Application No. PCT/JP2022/007781, filed Feb. 25, 2022, which international application claims priority to and the benefit of Japanese Application No. 2021-031472, filed Mar. 1, 2021; the contents of both of which are hereby incorporated by reference in their entirety.

### BACKGROUND

### Technical Field

The present invention relates to a technique for charging an energy storage cell.

### Description of Related Art

Patent Document JP 5525862 discloses constant current/constant voltage charging as a method for charging an energy storage cell.

### BRIEF SUMMARY

During charging, there is a case where a component to which electricity is supplied or an energy storage cell located on a current path generates heat due to Joule heat caused by a charge current. The component to which electricity is supplied is, for example, an electronic component such as a relay, a structural member such as a bus bar, or the like.

It is an object of the present invention is to realize charging of an energy storage cell while suppressing the generation of heat in a component to which electricity is supplied or in the energy storage cell.

A control device for an energy storage cell calculates an SOC or a remaining charge of the energy storage cell by a current integration method, and determines a command value of a charge voltage for the energy storage cell based on the SOC or the remaining charge obtained by the current integration method.

The present technique is applicable to a control device, an energy storage apparatus, a charging system, and a method for charging an energy storage cell.

The present configuration can charge an energy storage cell while preventing the generation of heat by a component to which electricity is supplied or by the energy storage cell

### BRIEF DESCRIPTION OF THE FIGURES

FIG. 1 is a side view of an automobile.

FIG. 2 is an exploded perspective view of a battery.

FIG. 3 is a plan view of a secondary battery cell.

FIG. 4 is a cross-sectional view of the secondary battery cell.

FIG. 5 is a circuit diagram of a battery.

FIG. 6 is a graph illustrating an SOC-OCV characteristic of a secondary battery.

FIG. 7 is a graph illustrating a charge voltage curve.

FIG. 8 is a view illustrating a look-up table.

FIG. 9 is a graph illustrating a charge voltage curve.

FIG. 10 is an enlarged view of a portion B in FIG. 9.

FIG. 11 is a mode transition diagram of a management device.

FIG. 12 is a flowchart of a control sequence of a charge voltage.

FIG. 13 is a diagram illustrating a relationship between a predetermined value of a charge voltage and a range B.

FIG. 14 is a graph illustrating a charging characteristic of a battery.

FIG. 15 is a graph illustrating a charging characteristic of a battery.

### DETAILED DESCRIPTION OF VARIOUS EMBODIMENTS

An overall configuration of a control device for an energy storage cell will be described.

A control device for an energy storage cell calculates an SOC or a remaining charge of the energy storage cell by a current integration method, and determines a command value of a charge voltage for the energy storage cell based on the SOC or the remaining charge obtained by the current integration method. The current integration method estimates an SOC based on an integrated value of a current that can be measured constantly. Therefore, by using the current integration method, unlike an OCV method and a full charge method, it is possible to successively calculate the SOC during charging. The OCV method is a method of estimating an SOC using the SOC-OCV correlation, and the full charge method is a method of setting an SOC at the time of full charge as 100%. Because the charge voltage is determined based on an SOC successively calculated by the current integration method, it is possible to perform a fine charge voltage control according to a change in the SOC during charging.

Therefore, a charge current can be controlled with high accuracy as compared with a case where the charge voltage is set to a fixed value regardless of the SOC. Accordingly, an energy storage cell can be charged while suppressing the generation of heat in a component to which electricity is supplied or in the energy storage cell, which is caused by Joule heat. Furthermore, unlike a feedback control where a charge voltage is adjusted to be increased or decreased corresponding to the deviation of a charge current with respect to a target value, the method performs a control by determining a charge voltage based on an SOC. Thus, the vibration (hunting) of a charge current due to a positive feedback minimally occurs. Substantially the same effect can be obtained also in a case where a command value of a charge voltage for the energy storage cell is determined based on a remaining charge instead of an SOC.

The control device may increase a command value of a charge voltage in a case where a charge current of the energy storage cell is smaller than a predetermined value. With such a configuration, in a case where a charge current becomes smaller than a predetermined value due to an SOC obtained by a current integration method or an estimation error of a remaining charge, by increasing a command value of a charge voltage, the charge current can take a value close to a predetermined value. By making the charge current take the value close to the predetermined value, it is possible to avoid the occurrence of a state where a charge current becomes zero in the course of charging so that charging is stopped. Accordingly, charging can be continuously performed. By continuing charging, it is possible to charge the energy storage cell to a target SOC or a target remaining charge.

The control device, in a case where a duration of a state that a charge current is smaller than a predetermined value is less than a threshold, may not increase a command value of a charge voltage. With such a configuration, in a case where a charge current temporarily becomes smaller than a predetermined value by being influenced by a current measurement error or noise, it is possible to suppress the increase of a command value of a charge voltage. Accordingly, it is possible to suppress the occurrence of a state where heat is generated in a component to which electricity is supplied or the energy storage cell due to the unintended increase of a charge voltage.

An SOC calculated by a current integration method or a remaining charge may be corrected to an SOC or a remaining charge when the energy storage cell is fully charged. With such a configuration, by correcting an SOC calculated using a current integration method or a remaining charge to an SOC(=100[%]) or a remaining charge (=fully charged capacity [Ah]) when the energy storage cell is fully charged, it is possible to eliminate an estimation error of an SOC calculated by a current integration method or a remaining charge. By eliminating an estimated error, estimation accuracy of an SOC or a remaining charge can be enhanced.

The energy storage apparatus includes the energy storage cell and the control device, and the control device may transmit a command value of a charge voltage to an external charge control device that controls a charge voltage for the energy storage apparatus. “External charge control device” is, for example a vehicle ECU in a case of a vehicle-mounted energy storage apparatus, and means a control device other than an energy storage apparatus that controls charging. With such a configuration, the charge control device controls a charge voltage for the energy storage apparatus in accordance with a command value transmitted from the energy storage apparatus. That is, charge voltage for the energy storage cell can be controlled by a cooperative operation of the control device and the charge control device. Such a configuration has an advantageous effect with respect to a point that the present technique is applicable to a charging system where a charge control function of the energy storage apparatus can be shared by “the control device for the energy storage apparatus” and “external charge control device”.

The above-mentioned energy storage cell is a secondary battery cell that has, with respect to an SOC-OCV characteristic, a low change region where a change amount of an OCV with respect to a change amount of an SOC is relatively low and a high change region where a change amount of the OCV with respect to a change amount of the SOC is relatively high, or a secondary battery cell that has, in a remaining charge-OCV characteristic, a low change region where a change amount of the OCV with respect to a change amount of a remaining charge is relatively low and a high change region where the change amount of the OCV with respect to the change amount of the remaining charge is relatively high. The above-mentioned control device, at least in the above-mentioned high change region, compares a charge current of the energy storage cell with a predetermined value, and may increase a command value of a charge voltage when the charge current of the energy storage cell is smaller than a predetermined value. In the secondary battery cell having the low change region and the high change region, due to an estimation error on an SOC or a remaining charge, in the high change region, a charge current becomes smaller than a predetermined value and hence, charging is liable to be stopped. By adopting the present configuration, in the high change region, it is possible to charge the energy storage cell to a target SOC or a target remaining charge without stopping charging in the course of charging.

The control device, in both regions of the low change region and the high change region, compares a charge current of the energy storage cell with a predetermined value, and may increase a command value of the charge voltage when the charge current of the energy storage cell is smaller than a predetermined value. With such a configuration, in both of the low change region and the high change region, when a charge current is smaller than a predetermined value, a charge voltage is increased. Accordingly, in all regions including the low change region and the high change region, it is possible to charge the energy storage cell to a target SOC without stopping charging in the course of a charging operation.

### Embodiment 1

1. Configuration of battery 50

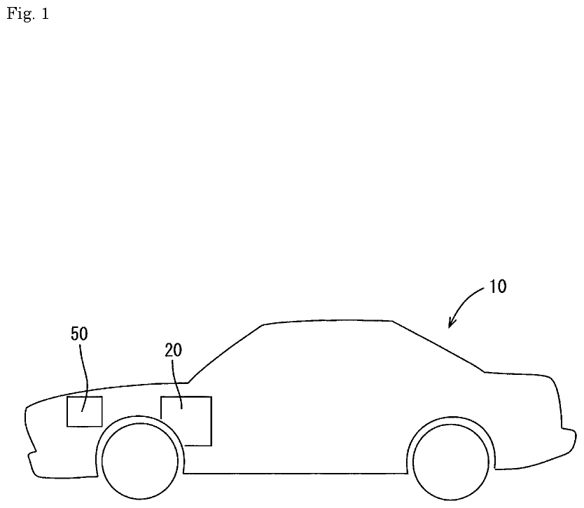

In the embodiment 1, an in-vehicle battery 50 is exemplified. FIG. 1 is a side view of an automobile. The automobile 10 includes an engine 20 as a drive device. In FIG. 1, only the engine 20 and the battery 50 are illustrated, and other parts constituting the automobile 10 are omitted. The battery 50 is an example of the energy storage apparatus.

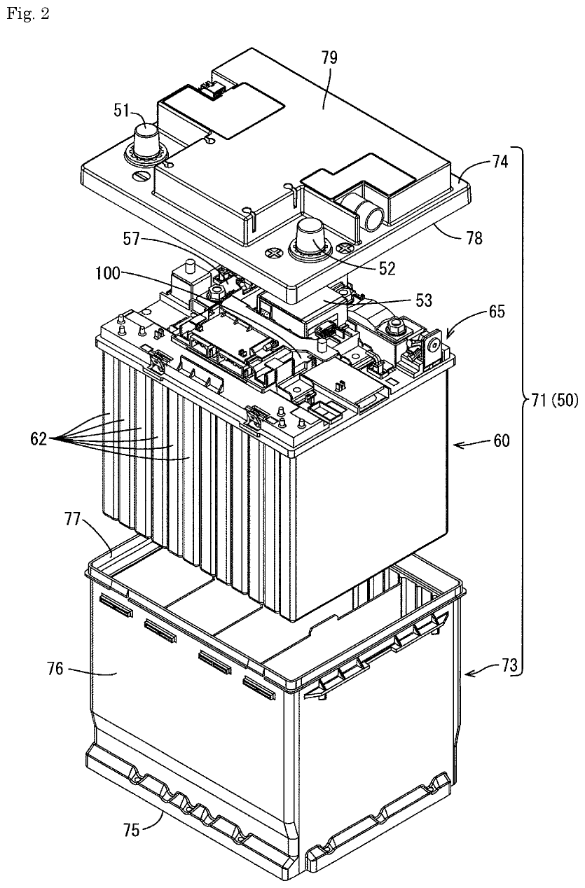

As illustrated in FIG. 2, the battery 50 includes an assembled battery 60, a circuit board unit 65, and a container 71.

The container 71 includes a body 73 made of a synthetic resin material, and a lid body 74. The body 73 has a bottomed cylindrical shape. The body 73 includes a bottom surface portion 75 and four side surface portions 76. An upper opening portion 77 is formed at an upper end portion of the body 73 by four side surface portions 76.

The container 71 contains the assembled battery 60 and a circuit board unit 65. The assembled battery 60 has twelve secondary battery cells 62. Twelve secondary battery cells 62 are connected with each other in three parallels and four series.

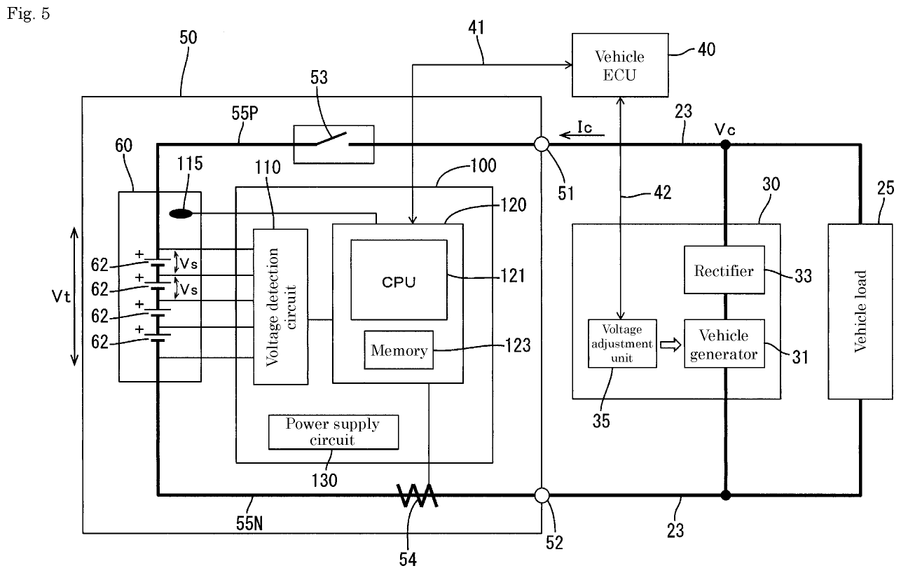

The circuit board unit 65 is disposed above the assembled battery 60. The circuit board unit includes bus bars 57 that form power lines 55 of the assembled battery 60. In the block diagram in FIG. 5, three secondary battery cells 62 that are connected in parallel are indicated by one battery signal. The secondary battery cell 62 is an example of “energy storage cell”.

The lid body 74 closes the upper opening portion 77 of the body 73. An outer peripheral wall 78 is formed on a periphery of the lid body 74. The lid body 74 has a protruding portion 79 having an approximately T shape as viewed in a plan view. On a front portion of the lid body 74, an external terminal 51 of positive electrode is fixed to one corner portion, and an external terminal 52 of a negative electrode is fixed to the other corner portion.

The battery 50 supplies power to a load connected to the external terminals 51, 52 of positive and negative electrodes. The battery 50 is charged by a generator 30 connected to the external terminals 51, 52 of positive and negative electrodes.

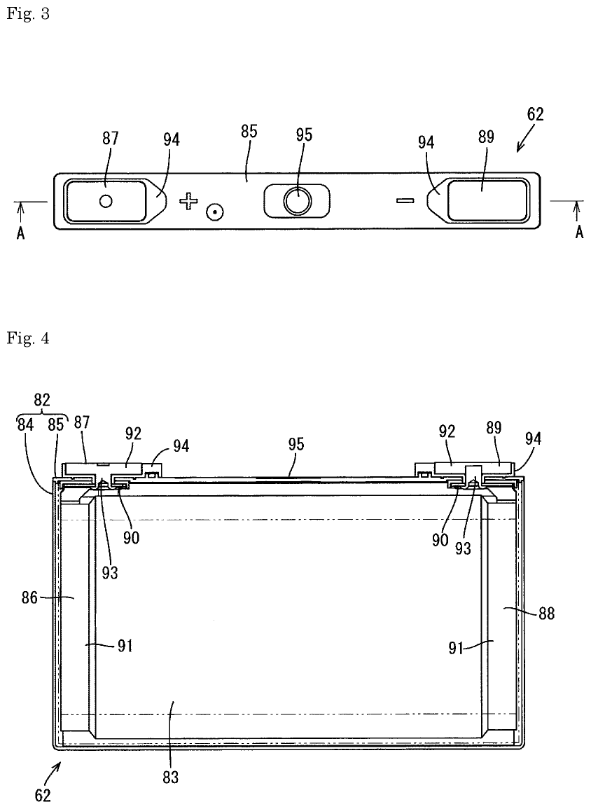

As illustrated in FIG. 3 and FIG. 4, the secondary battery cell 62 is configured such that an electrode assembly 83 is accommodated in a case 82 having a rectangular parallelepiped shape together with a nonaqueous electrolyte. The case 82 includes a case body 84 and a lid 85 that closes an opening portion formed at an upper portion of the case body 84.

Although not illustrated in detail, the electrode assembly 83 is formed such that a separator formed of a porous resin film is disposed between a negative electrode element that is formed by applying an active material to a substrate formed of a copper foil, and a positive electrode element that is formed by applying an active material to a substrate formed of an aluminum foil.

These elements all have a strip shape, and wound in a flat shape so as to be accommodated in the case body 84 in a state where the position of the negative electrode element and the position of the positive electrode element are displaced toward opposite sides in the width direction with respect to the separator.

A positive electrode terminal 87 is connected to the positive electrode element via a positive electrode current collector 86, and a negative electrode terminal 89 is connected to the negative electrode element via a negative electrode current collector 88. The positive electrode current collector 86 and the negative electrode current collector 88 are each formed of a flat plate-like pedestal portion 90 and a leg portion 91 extending from the pedestal portion 90. A through hole is formed in the pedestal portion 90. The leg portion 91 is connected to the positive electrode element or the negative electrode element.

The positive electrode terminal 87 and the negative electrode terminal 89 each include: a terminal body portion 92; and a shaft portion 93 protruding downward from a center portion of a lower surface of the terminal body portion 92. In such a configuration, the terminal body portion 92 and the shaft portion 93 of the positive electrode terminal 87 are integrally formed with each other using aluminum (a single material). In the negative electrode terminal 89, the terminal body portion 92 is made of aluminum, and the shaft portion 93 is made of copper. The negative electrode terminal 89 is formed by assembling the terminal body portion 92 and the shaft portion 93 to each other.

The terminal body portion 92 of the positive electrode terminal 87 and the terminal body portion 92 of the negative electrode terminal 89 are disposed at both end portions of the lid 85 via gaskets 94 made of an insulating material. The terminal body portion 92 of the positive electrode terminal 87 and the terminal body portion 92 of the negative electrode terminal 89 are exposed outward from the gaskets 94.

The lid 85 has a pressure release valve 95. As illustrated in FIG. 3, the pressure release valve 95 is positioned between the positive electrode terminal 87 and the negative electrode terminal 89. The pressure release valve 95 is released when an internal pressure in the case 82 exceeds a limit value so as to lower the internal pressure in the case 82.

The electrical configuration of the battery 50 will be described with reference to FIG. 5. The battery 50 includes an interrupting device 53, the assembled battery 60, a current detection unit 54, a management device 100, and a temperature sensor 115.

The assembled battery 60 is formed of a plurality of secondary battery cells 62 connected in series. In this embodiment, the number of cells connected in series is “4”. The secondary battery cell 62 is an example of “energy storage cell” according to the present invention.

The positive electrode of the assembled battery 60 is connected to the external terminal 51 on the positive electrode side via a power line 55P. The negative electrode of the assembled battery 60 is connected to the external terminal 52 on the negative electrode side via a power line 55N.

The interrupting device 53 is positioned on the positive electrode side of the assembled battery 60, and is disposed on the power line 55P of a positive electrode side. As the interrupting device 53, a relay or an FET can be used.

The interrupting device 53 is controlled to a CLOSE state (normally close) in a normal operation. When an abnormality occurs in the battery 50, a current is interrupted using the interrupting device 53 and hence, it is possible to protect the battery 50.

The current detection unit 54 detects the current I [A] of the assembled battery 60. The current detection unit 54 may be a resistor. The current detection unit 54 of a resistance type can determine discharging and charging based on the polarity (positive or negative) of a voltage. The current detection unit 54 may be a magnetic sensor. A temperature sensor 115 is a contact type sensor or a non-contact type sensor. The temperature sensor 115 measures a temperature T[° C.] of the assembled battery 60.

The management device 100 is mounted on the circuit board unit 65. The management device 100 includes a voltage detection circuit 110, a control device 120, and a power supply circuit 130.

The voltage detection circuit 110 is connected to both ends of each secondary battery cell 62 by a signal lines, and measures the cell voltage Vs of each secondary battery cell 62. Further, the total voltage Vt of the assembled battery 60 is measured based on the cell voltages Vs of the respective secondary battery cells 62. The total voltage Vt of the assembled battery 60 is a sum of voltages of four secondary battery cells 62 connected in series.

The control device 120 includes a CPU 121 having an arithmetic operation function and a memory 123 which is a storage unit. The control device 120 monitors the current I of the assembled battery 60, the cell voltages Vs of the respective secondary battery cells 62, the total voltage Vt of the assembled battery 60, and a temperature T based on an output of the current detection unit 54, an output of the voltage detection circuit 110, and an output of the temperature sensor 115. Further, a charge voltage Vc can be detected based on a voltage of the external terminal 51.

The memory 123 is a nonvolatile storage medium such as a flash memory or an EEPROM. The memory 123 stores a monitoring program for monitoring the state of the assembled battery 60 and data necessary for executing the monitoring program.

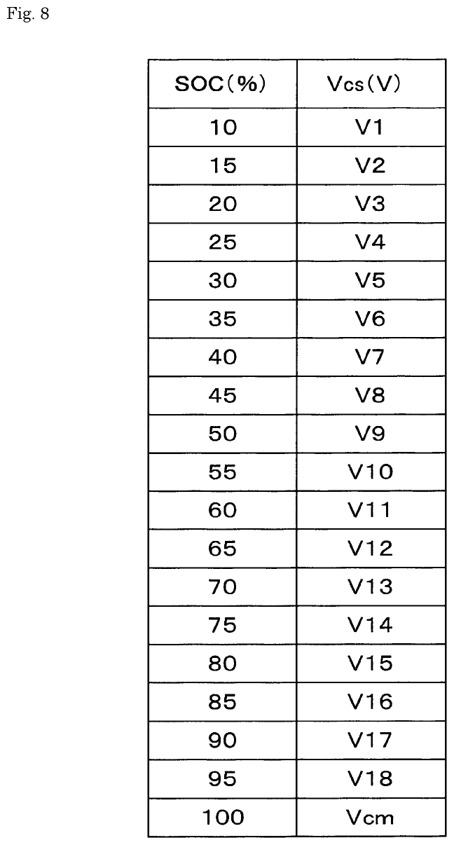

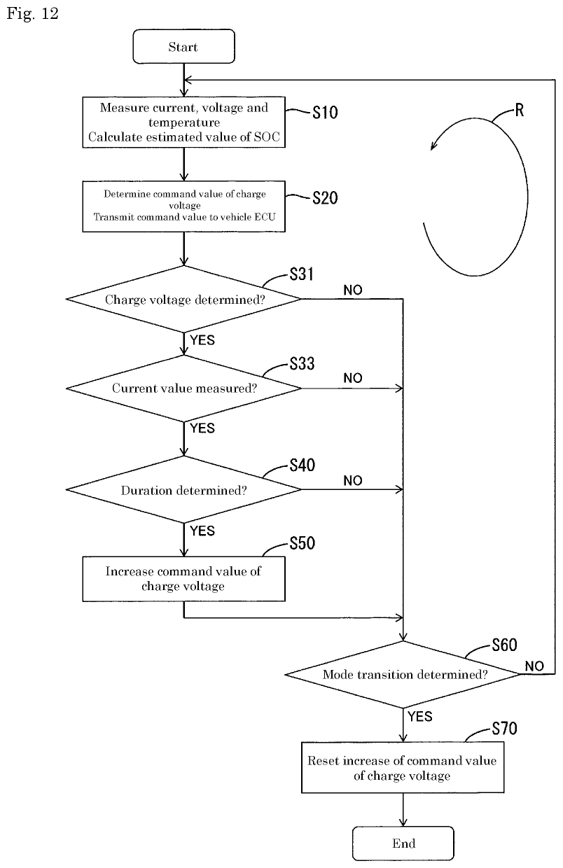

The memory 123 stores a control program for executing a control sequence of a charge voltage Vc of the battery 50 (FIG. 12), and data necessary for executing the control program. The data necessary for executing the control program includes the data of the look-up table illustrated in FIG. 8.

A vehicle load 25 and the generator 30 are connected to battery 50 via a wiring 23. The vehicle load 25 may be an engine starting device or auxiliary equipment. The engine starting device is a motor that starts an engine. The auxiliary equipment is formed of headlights, power steering mechanisms, air conditioners, an audio set, and the like.

The generator 30 includes a vehicle generator 31, a rectifier 33, and a voltage adjustment unit 35. The vehicle generator 31 is an alternating current generator that generates power by the power of the engine 20. The rectifier 33 converts power outputted from the vehicle generator 31 from an alternating current to a direct current by a rectifying operation.

The voltage adjustment unit 35 adjusts an output voltage Vc of the generator 30. In the voltage adjustment, an output voltage Vc may be adjusted by controlling an excitation current of the vehicle generator 31. A method that performs a PWM control of an output voltage Vc may be also adopted.

When a power generation amount of the generator 30 exceeds an amount of electric load of the vehicle load 25, the battery 50 can be charged by the generator 30. The power generation amount of the generator 30 is smaller than an amount of electric load of the vehicle load 25, the battery 50 is discharged so as to compensate for a shortage of the power generation amount. The generator 30 is an example of a power device that generates power.

A vehicle electronic control unit (ECU) 40 is communicably connected with the battery 50 via a communication line 41, and is communicably connected with the generator 30 via a communication line 42.

The vehicle ECU 40 controls an output voltage Vc of the generator 30, that is, a charge voltage Vc of the battery 50 by controlling the voltage adjustment unit 35 based on a command value of a charge voltage Vc transmitted from the battery 50. The vehicle ECU 40 corresponds to “external charge control device” of the present invention. “External” means the outside of the battery.

### 2. OCV Characteristic and SOC Estimation of Secondary Battery Cell 62

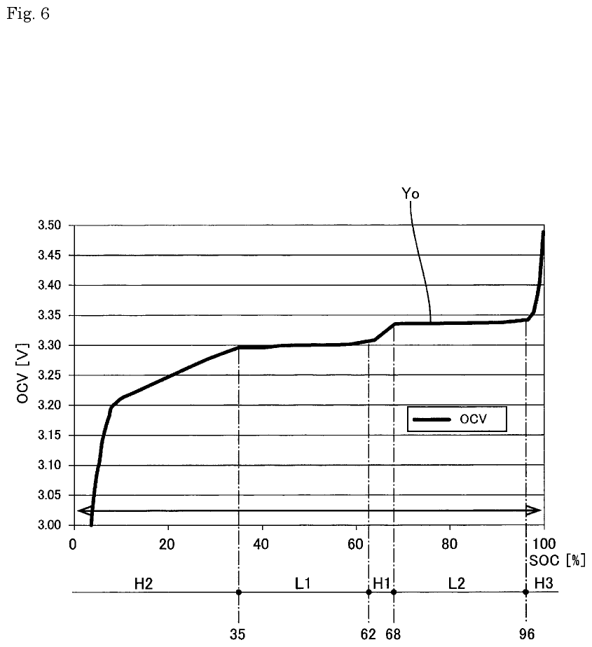

In FIG. 6, SOC [%] is taken on an axis of abscissas and an OCV [V] is taken on an axis of ordinate. FIG. 6 illustrates a SOC-OCV correlation characteristic Yo of the secondary battery cell 62. Hereinafter, “Yo” is referred to as “OCV curve”.

SOC (charge state) is a rate of a remaining charge with respect to a full charge capacity, and SOC can be expressed by a following expression (1).

OCV is an open circuit voltage of the secondary battery cell 62. The open circuit voltage is a both-end voltage of the secondary battery cell 62 in a case where there is no current or it is considered that there is no current.

SOC=(Cr/Co)×100 (1)

In the expression, Co is a full charge capacity of the secondary battery cell, and Cr is the remaining charge of the secondary battery cell.

As illustrated in FIG. 6, the secondary battery cell 62 has a plurality of charge regions including: a low change region L where a change amount of OCV with respect to a change amount of SOC is relatively low; and a high change region H where the change amount of OCV with respect to the change amount of SOC is relatively high.

To be more specific, the secondary battery cell 62 includes two low change regions L1, L2, and three high change regions H1, H2, H3.

As illustrated in FIG. 6, the low change region L1 is positioned within a range of 35[%] to 62[%] with respect to the value of SOC, and the low change region L2 is positioned within a range of 68[%] to 96[%] with respect to the value of SOC.

The low change regions L1, L2 are plateau regions where a change amount of OCV relative to a change amount of SOC is extremely small, and OCV takes approximately fixed values of 3.3[V] and 3.35[V]. The plateau region is a region where a change amount of OCV relative to a change amount of SOC is equal to or less than a determination value. The determination value is 2 [mV/%], as an example.

The first high change region H1 falls within a range larger than 62[%] and less than 68[%] with respect to the value of SOC, and is positioned between two low change regions L1, L2. The second high change regions H2 falls within a range of less than 35[%] with respect to the value of SOC, and is positioned on a lower SOC side than the low change region L1. The third high change region H3 falls within a range larger than 96[%] with respect to the value of SOC, and is positioned on a higher SOC side than the low change region L2.

The first to the third high change regions H1 to H3 have a relationship with the low change regions L1, L2 where a change amount of OCV relative to a change amount of SOC (a gradient of a graph illustrated in FIG. 6) is relatively high compared to the low change regions L1, L2.

In the SOC-OCV correlation characteristics, as the secondary battery cell 62 that has the above-mentioned plateau regions L1 and L2, there is an iron phosphate-based lithium ion battery cell using lithium iron phosphate (LiFePO4) as a positive active material and graphite as a negative active material.

In the plateau regions L1, L2, OCV hardly changes relative to the change of SOC. Accordingly, in the secondary battery cell 62 that has the plateau regions L1, L2, it is difficult to estimate SOC based on correlation between SOC and OCV.

The management device 100 estimates SOC of the secondary battery cell 62 using a current integration method. The current integration method estimates SOC [%] based on a time integrated value of a current I as expressed by expression (2). The symbol of the current I takes plus at the time of charging and takes minus at the time of discharging. The use of the current integration method is not limited to SOC, and a remaining charge Cr can also be calculated using a current integration method.

SOC=SOCo+100×(∫Idt/Co) (2)
SOCo is an initial value of SOC, and I is a current.

### 3. Determination of Command Value of Charge Voltage Vcs of Secondary Battery Cell 62.

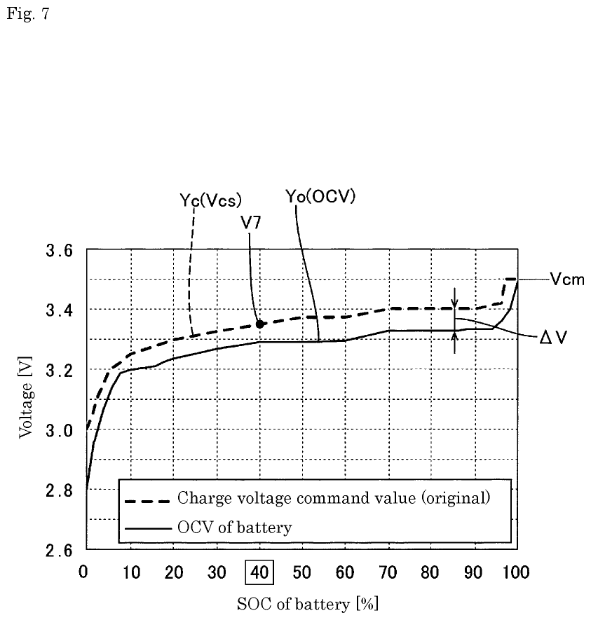

FIG. 7 illustrates a charge voltage curve Yc. In the graph where the SOC [%] is taken on an axis of abscissas and a voltage [V] is taken on an axis of ordinate, the charge voltage curve Yc indicates a charge voltage Vcs of the secondary battery cell 62 with respect to each SOC.

In all SOCs, the charge voltage curve Yc is higher than an OCV curve Yo, and the higher the SOC, the higher a charge voltage Vcs becomes. The secondary battery cell 62 can be charged by making use of a potential difference ΔV between Vcs and OCV. The relationship between the voltage difference ΔV and a charge current Ic is expressed as follows.

Ic=ΔV/r (3)
“r” is an internal resistance of the secondary battery cell.

By determining the voltage difference ΔV such that the charge current Ic does not exceed a maximum allowable current Im, Vcs can be determined as expressed by expression (4). The charge voltage curve Yc can be determined by obtaining Vcs with respective SOCs.

Vcs=OCV+ΔV (4)

The voltage difference ΔV can also be determined such that the charge current Ic becomes a constant current except for a region near a fully charged state.

ΔV/r=Const(less than Im in the expression)

In a region near a fully charged state, the voltage of the secondary battery cell 62 sharply rises. In the region near the fully charged state, the voltage difference ΔV becomes small and hence, the charge current Ic is small compared to other regions.

The memory 123 stores a look-up table of the charge voltage curve Ycs. The look-up table is a table that is stored by making SOC and the charge voltage Vcs correlating with each other (see FIG. 8).

The management device 100 estimates SOC of the secondary battery cell 62 using a current integration method, and determines a command value of a charge voltage Vcs per one cell by looking up the obtained SOC in the look-up table.

Then, by controlling an output voltage Vc of the generator 30 based on the command value of the charge voltage Vcs, the battery 50 can be charged while suppressing a charge current Ic to a value equal to or less than a maximum allowable current value Im.

In the charge voltage curve Ycs, the voltage difference ΔV with respect to OCV is set such that a charge current Ic becomes a value equal to or less than a maximum allowable current value Im. Accordingly, during charging, it is possible to suppress the generation of heat in components to which electricity is supplied positioned on a current path and the secondary battery cell 62. The electricity supply parts are the interrupting device 53, the bus bars 57 and the like.

### 4. Decrease of Voltage Difference ΔV Due to Error in Estimation of SOC

In a current integration method, measurement errors of a charging/discharging current Ic detected by the current detection unit 54 are cumulated along with a lapse of time and hence, an error in the estimation of the SOC occurs.

When an error in the estimation of the SOC occurs, a voltage difference ΔV between a charge voltage Vcs and OCV fluctuates compared to a case where there is no estimation error of SOC and hence, there is a case where the voltage difference ΔV becomes small. Further, there may be a case where the magnitude relationship of the voltage is reversed.

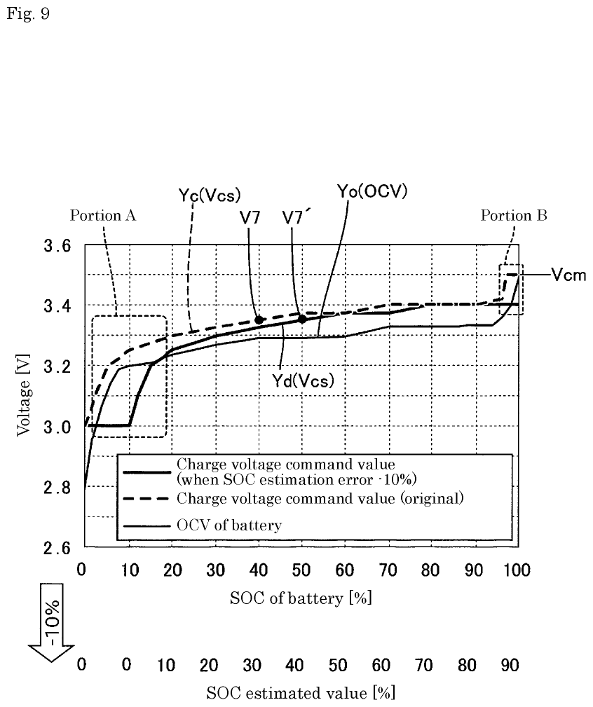

For example, in a case where SOC has a minus estimation error with respect to a true value, as illustrated in FIG. 9, the position of the charge voltage curve Yc is displaced in the right direction of an SOC axis (an axis of abscissas) by an amount corresponding to the estimation error. In the example illustrated in FIG. 9, an error in the estimation of the SOC is −10%. Accordingly, a charge voltage curve Yd when the estimation error occurs is displaced by 10% in the right direction from the charge voltage curve Yc when there is no estimation error. The point “V7” is displaced to the point “V7′”.

To compare Yd-Yo (having an estimation error) in FIG. 9 with Yc-Yo (having no estimation error) in FIG. 7, a voltage difference ΔV fluctuates within a range of SOC of 2% to 18% (a portion A in FIG. 9) and a range of SOC of 95% to 100% (a portion B in FIG. 9).

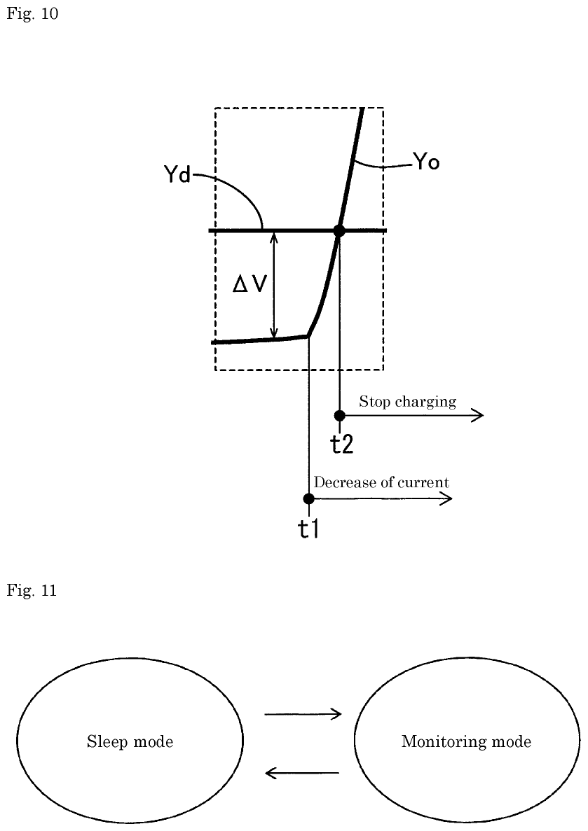

FIG. 10 is a view illustrating the portion B in FIG. 9 in an enlarged manner. To compare Yd-Yo (having an estimation error) in FIG. 9 with Yc-Yo (having no estimation error) in FIG. 7, the voltage difference ΔV is decreased after a point of time t1, and the magnitude relationship of the voltage is reversed at a point of time t2.

After the point of time t1 where the voltage difference ΔV is decreased, compared to the case having no SOC estimation error, a charge current Ic becomes small, and after the point of time t2 where the magnitude relationship of the voltage is reversed, there is a possibility that charging is stopped. Such fluctuation of voltage difference ΔV is liable to occur on the high change regions H1, H2.

The management device 100 performs a control of increasing a charge voltage Vc in a case where a charge current Ic is smaller than a predetermined value Ib1.

The predetermined value Ib1 is a value for determining whether or not an operation can be performed without stopping charging, and the predetermined value Ib1 is smaller than an expected value Ic0 of the charge current Ic. The expected value Ic0 is a theoretical value of the charge current Ic determined based on the expression (3). The predetermined value Ib1 may be a numerical value shared in common by the respective SOCs or may be a unique numerical value.

By increasing a charge voltage Vc, a value of a voltage difference ΔV between a charge voltage Vcs and the OCV can be made larger than a value of the voltage difference ΔV before the charge voltage Vc is increased and hence, it is possible to bring a charge current Ic close to an expected value Ic0. Accordingly, it is possible to suppress the occurrence of a state where a charge current Ic becomes zero during charging so that the charging is stopped. Accordingly, the charging can be continuously performed.

The charge voltage Vc may be increased within a range where the charge voltage does not exceed a maximum value Vcm in terms of the charge voltage Vcs per one cell. The maximum value Vcm is the charge voltage Vcs of the SOC 100 [%] (see FIGS. 7 and 9).

### 5. Mode Transition and Control Sequence of Charge Voltage Vc in Management Device 100

As illustrated in FIG. 11, two modes consisting of a monitoring mode and a sleep mode are set in the management device 100.

The monitoring mode is a mode where the state of the battery 50 is monitored at predetermined cycles N, and the sleep mode is a mode where a part of a monitoring function is stopped so as to suppress the power consumption of the management device 100.

The management device 100 performs the mode transition by determining the non-use or the use of the battery 50 based on a current I supplied from the battery 50. That is, when the current I is less than a current determination value (determined that the current I is not used), the mode is shifted to the sleep mode. On the other hand, when the current I is equal to or more than the current determination value (determined the current is used), the mode is shifted to the monitoring mode.

When the automobile 10 is parked, the battery 50 is in a non-use state where it is neither charged nor discharged, so that the current I becomes less than the current determination value, and the management device 100 shifts to the sleep mode. On the other hand, in a state other than parking such as a state where an automobile 10 is traveling, a state where the automobile 10 is stopping or a state where the automobile 10 is in an idling stop, charging/discharging are performed with the automobile 10 so that the battery 50 is assumed to be in a use state. Then, the mode of the management device 100 is shifted to the monitoring mode.

The management device 100 starts a control sequence of a charge voltage Vc using shifting of the mode to the monitoring mode as a trigger.

As illustrated in FIG. 12, the control sequence of a charge voltage Vc is constituted of seven steps from S10 to S70.

When the control sequence starts, the management device 100 measures a current I of the assembled battery 60, cell voltages Vs of the respective secondary battery cells 62, a total voltage Vt of the assembled battery 60, and a temperature T of the assembled battery 60 using the measurement devices such as the current detection unit 54, the voltage detection circuit 110, and the temperature sensor 115. Then, the management device 100 estimates the SOC of the assembled battery 60 by a current integration method (S10).

Next, the management device 100 determines a command value of a charge voltage Vcs per one cell from the SOC obtained using the current integration method.

The charge voltage Vcs per one cell can be determined by looking up the look-up table (FIG. 8) where the SOC is stored in the memory 123. For example, in a case where the SOC is set such that SOC=40 [%], a command value of a charge voltage Vcs corresponding to one cell is “V7”.

Thereafter, the management device 100 transmits the command value of the charge voltage Vc to the vehicle ECU 40 (S20). The management device 100 transmits the SOC of the battery 50 together with the command value of the charge voltage Vc. Due to the transmission of the information on the SOC, the vehicle ECU 40 can monitor the SOC of the battery 50.

A command value to be transmitted to the vehicle ECU 40 is a command value of a charge voltage Vc of the battery 50. That is, the command value is a value obtained by multiplying the charge voltage Vcs per one cell determined using the look-up table illustrated in FIG. 8 by the number of cells “4”.

When the vehicle ECU 40 receives the command value of the charge voltage Vc, the vehicle ECU 40 controls an output voltage Vc of the generator 30 to the received command value.

After transmitting the command value, the management device 100 determines the magnitude of the charge voltage Vc (S31). More specifically, the management device 100 determines whether a difference between a command value Vco of a charge voltage Vc and a measured value Vct is smaller than a comparison value A. The charge voltage (measured value) Vct can be measured using, for example, a voltage of the external terminal 51 of the battery 50.

Vco−Vct≤A (4)

A measured value Vct of the charge voltage Vc takes a value smaller than a command value Vco due to a voltage drop generated by a resistance of a wiring or the like. In a case where the difference between the command value Vco and the measured value Vct is smaller than a comparison value A (S31: YES), the generator 30 outputs power in accordance with the command value, and it can be determined that the battery 50 is being charged at a commanded charge voltage Vc.

When the determination in S31 is YES, the management device 100 determines whether or not a charge current Ic is smaller than a predetermined value Ib1.

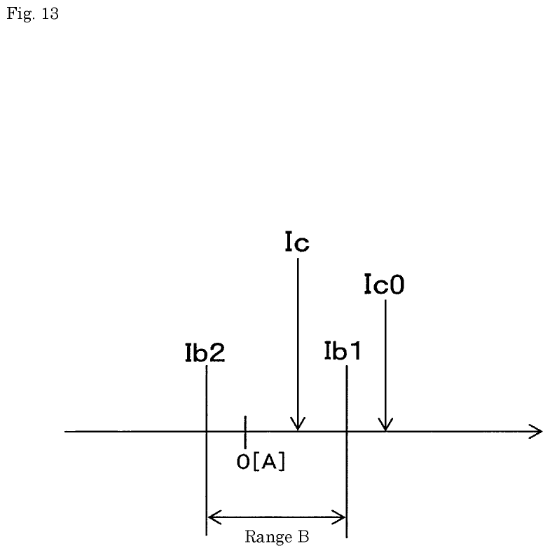

In this embodiment, the charge current Ic is compared with a range B (see FIG. 13). The range B is a range (Ib1 to Ib2) where a current value is smaller than the predetermined value Ib1 and includes zero.

Ib2<B<Ib1 (5)

B may take different values in accordance with SOCs, or may take the same value shared in common by all SOCs.

When the charge current Ic falls within the range B, it is determined that the charge current Ic is smaller than the predetermined value Ib1 (YES in S33).

When the charge current Ic is equal to or more than the predetermined value Ib1 (NO in S33), the management device 100 determines whether or not there is the mode transition from a monitoring mode to a sleep mode (S60). When there is no mode transition and the monitoring mode is continued (NO in S60), the processing returns to S10.

In a case where, after the start of the control sequence, the generator 30 outputs power in accordance with a command value (YES in S31), a charge current Ic is a predetermined value Ib1 (NO in S33), and there is no mode transition from a monitoring mode (NO in S60), the processing in steps S10, S20, S31, and S60 is repeated at a predetermined cycle N (loop R).

As a result, a current I of the assembled battery 60, cell voltages Vs of respective secondary battery cells, a total voltage Vt of the assembled battery, and a temperature T are measured at a predetermined cycle N, and an SOC of the assembled battery 60 is successively calculated based on an integrated value of measured currents I.

The control device 120 successively calculates the SOCs using a current integration method, and determines command values of charge voltages Vc of the battery 50 corresponding to the successively calculated respective SOCs by looking up the look-up table illustrated in FIG. 8. During charging, the control device 120 transmits information on the command values of the charge voltages Vc corresponding to the respective SOCs together with information on the respective SOCs to the vehicle ECU 40. The vehicle ECU 40 controls the generator 30 so as to control the output voltages Vc of the generator 30 to the command values. As a result, during charging, the charge voltage Vc can be continuously changed corresponding to the continuously changing SOC. Accordingly, the battery 50 can be charged while controlling a charge current Ic to a constant current equal to or less than a maximum allowable current value Im.

Next, the case is described where a charge current Ic is smaller than a predetermined value Ib1 during charging (YES in S33).

When the determination is YES in S33, the management device 100 counts a duration Ts of a state where a charge current Ic is smaller than a predetermined value Ib1 (a state that is included in the range B), and determines the duration Ts as a threshold D [s] (S40).

The threshold D is a value for verifying whether a state where the charge current Ic is smaller than the predetermined value Ib1 is maintained in order to avoid an erroneous detection caused by an error in voltage measurement or noise.

When the duration Ts is longer than the threshold D, the management device 100 transmits a command to increase a command value of a charge voltage Vc from a current value to the vehicle ECU 40 (S50).

By increasing a charge voltage Vc, a value of a voltage difference ΔV between a charge voltage Vcs and the OCV can be made larger than a value of the voltage difference ΔV before the charge voltage Vc is increased and hence, it is possible to bring a charge current Ic close to an expected value Ic0. Accordingly, it is possible to suppress the occurrence of a state where a charge current Ic becomes zero during charging so that the charging is stopped. Accordingly, the charging of the battery 50 can be continuously performed.

With respect to the flow of processing after a command value of a charge voltage Vc is increased, the processing advances to S60. In S60, the presence or the non-presence of the mode transition is determined. If there is no mode transition, the flow returns to S10.

When the duration Ts is less than the threshold D, the processing advances to S60 without advancing to S50. Therefore, the increase of a command value of a charge voltage Vc is not performed, and the command value of the charge voltage Vc is maintained at the present value.

When the automobile 10 shifts from traveling to parking so that the mode transition from the monitoring mode to the sleep mode takes place, the processing advances to S70.

When the processing advances to S70, the management device 100 resets the increase of a command value of a charge voltage Vc. Resetting means that a command value of a charge voltage Vc is returned to an initial state before the increase of the command value of the charge voltage Vc. As a result, the control sequence of the charge voltage Vc is completed.

Even when the battery 50 is charged to a target SOC, the processing advances to S70. In S70, the increase of the command value of the charge voltage Vc is reset, and the control sequence of the charge voltage Vc is completed.

The target SOC may be a fully charged state or may be a state other than the fully charged state. The target SOC and the completion of charging may be determined by the vehicle ECU 40 and may be controlled by the vehicle ECU 40. Alternatively, the target SOC and the completion of charging may be determined by the management device 100 and may be controlled by the management device 100.

The control sequence illustrated in FIG. 12 is always performed both in a case where the secondary battery cell 62 is in the low change regions L1 and L2 and in a case where the secondary battery cell 62 is in the high change regions H1 to H3 after starting the charging.

By constantly performing the control sequence, whatever region the secondary battery cell 62 is arranged, it is possible to perform charging with substantially an expected value Ic0. Accordingly, it is possible to charge the secondary battery cell 62 while suppressing the generation of heat in the secondary battery cell 62 and the components 57 to which electricity is supplied.

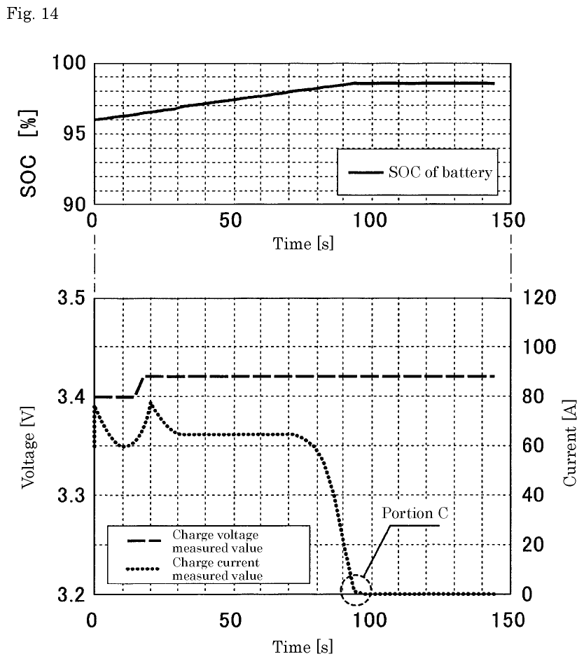

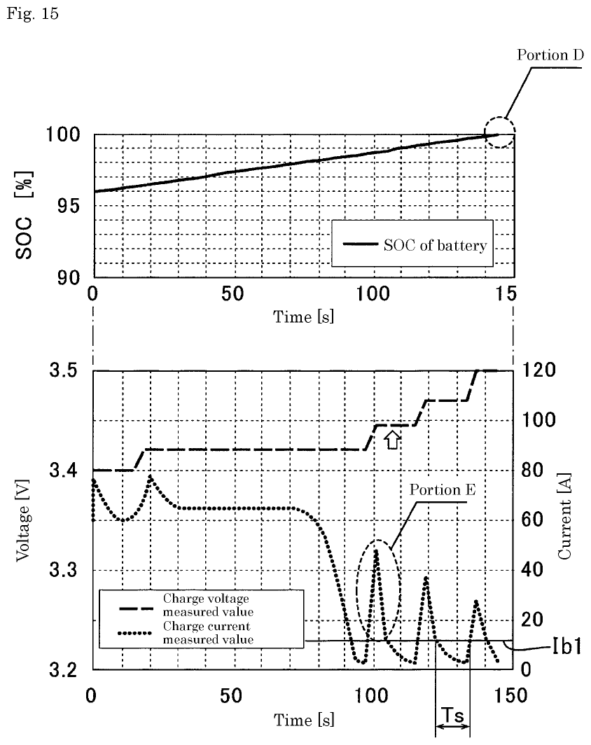

FIGS. 14 and 15 are diagrams illustrating charging characteristics of the battery 50. FIGS. 14 and 15 illustrate the transition of an SOC when a charge voltage Vc is controlled in accordance with a charge voltage curve Yc. The stop of charging (a part C indicated in the drawing) occurs at a point of time that approximately 95 [s] elapse from the start of charging due to an error in the estimation of the SOC. The SOC at a point of time that charging is started is 96%.

When the increase of the charge voltage Vc is not performed (FIG. 14), charging can be performed only up to the SOC of approximately 98.5 [%].

When the increase of the charge voltage Vc is performed (FIG. 15), it is possible continue the charging by suppressing of the stop of charging.

In an example illustrated in FIG. 15, a state where a charge current Ic falls within the range B (a state where the charge current Ic is below an upper limit value Ib1 of the range B) occurs 3 times. Therefore, the increase of the command value of the charge voltage Vc is performed three times, and in the final increase of the command value of the charge voltage Vc, the battery can be fully charged, that is, the battery is charged to the SOC of 100 [%] (part D). The “full charge” is a state where the secondary battery cell 62 is charged until a predetermined charge completion condition is reached, and generally, SOC=100 [%]. As the predetermined charging completion condition, for example, a charging time after the secondary battery cell 62 reaches a predetermined upper limit voltage can be set as the charging completion condition. When the battery is charged for 10 minutes after reaching the upper limit voltage, the battery is fully charged.

When a command value of a charge voltage Vc is increased, an inrush current flows into the battery 50 and hence, a current value is temporarily increased. When the current value temporarily increases, the polarization occurs in the secondary battery cell 62 so that a resistance value is increased. Accordingly, when a current passes a peak, the current is decreased. From the above, along with the increase of a command value of a charge voltage Vc, a waveform of the charge current Ic takes a sharp wave shape (portion E).

### 6. Description of Advantageous Effects

In the configuration described above, a command value of a charge voltage Vc is determined corresponding to an SOC obtained by a current integration method. In the configuration described above, compared to a case where a charge voltage Vc is set to a fixed value that does not depend on an SOC (for example, in a case of Vcm in terms of 1 cell), a charge voltage Vc and a charge current Ic of the battery 50 can be precisely controlled in accordance with the SOC of the battery 50.

Specifically, by setting the relationship between the SOC and the charge voltage Vc such that the higher the SOC, the higher the charge voltage Vc becomes within a range where the charge current Ic does not exceed the maximum allowable current Im, the secondary battery cell 62 can be charged while suppressing the generation of heat in the component to which electricity is supplied and the secondary battery cell 62 caused by Joule heat with respect to all SOCs from the low SOC to the high SOC.

The battery 50 may manage the use range of the SOC, and for example, in a case where the use range is 60˜80 [%], when charging is started at 70 [%], the charging may be completed when the SOC reaches 80 [%]. In the configuration of this embodiment, the charge voltage Vc is determined using the SOC which is the management information for controlling the charge. Accordingly, the information necessary for a charge control can be minimized while enabling a precise charge control.

As a method of suppressing the generation of heat in the secondary battery cell 62 during charging, considered is a method of performing a feedback control of a charge voltage Vc such that a charge current Ic agrees with an expected value Ic0. However, in the feedback control, there is a concern that a charge current Ic that is a controlled object may generate oscillation (hunting) by being influenced by the delay of a signal (for example, the delay of a signal delay due to communication between the control device 120 and the vehicle ECU 40) or the like. The configuration of this embodiment adopts a control of changing a charge voltage Vc in accordance with an SOC and hence, the configuration acquires an advantageous effect that a charge current Ic is easily stabilized as compared with a feedback control.

As a method of correcting an error in the estimation of the SOC, a correction method that uses an OCV method and a correction method where the battery 50 is charged to a fully charged state are named.

The OCV method is a method of obtaining the SOC by making use of the correlation between the OCV and the SOC. The correction method that uses an OCV method is a method where the SOC is calculated by a current integration method and the OCV method respectively, and the SOC obtained by the current integration method is corrected to the SOC obtained by the OCV method. By correcting the SOC in this manner, an error in the estimation of the SOC obtained by the current integration method can be eliminated. The OCV method has a problem that it takes time to specify the OCV (an open circuit voltage) of the secondary battery cell 62 (requiring stabilization time until the voltage is stabilized).

The correction method of performing charging to a fully charged state is a method of charging the battery 50 to a fully charged state and of correcting the SOC obtained by the current integration method to the SOC in a fully charged state (SOC=100 [%]). By correcting the SOC to the SOC in a fully charged state (SOC=100 [%]), an error in the estimation of the SOC obtained by the current integration method can be eliminated.

In any one of the correction methods, the corrected SOC is set to an initial value (SOC=100 [%] in the case of the correction method performed by full charging), and the SOC is estimated by the current integration method after the correction is made.

In a case where the battery 50 is operated in a range less than a fully charged state as a use range, for example, when the SOC falls within a range of from 60 to 80 [%], the battery 50 is normally charged within the use range. On the other hand, at a stage where errors in the estimation of SOC are accumulated due to a lapse of a predetermined period from the previous correction, the battery 50 is charged to a fully charged state so that the SOC by a current integration method can be corrected.

However, there may be a case where, at the time of charging the battery 50 to a fully charged state, errors in the estimation of SOC are accumulated and hence, as described with reference to FIG. 14, the charging is stopped in the course of the charging so that the full charging is not achieved and the SOC cannot be corrected. In this case, the estimation of the SOC by a current integration method is continued without eliminating errors in the estimation and hence, the errors in the estimation of the SOC are increased beyond an allowable value.

In the configuration of this embodiment, as illustrated in FIG. 15, when the charge current Ic becomes smaller than a predetermined value Ib1 due to errors in the estimation of the SOC, a command value of a charge voltage Vc is increased. By increasing the command value, it is possible to charge the secondary battery cell 62 to a fully charged state (SOC of 100 [%]) while suppressing the stop of charging in the course of the charging. Therefore, by correcting the SOC obtained by a current integration method to the SOC in a fully charged state (SOC of 100 [%]), errors in the estimation of the SOC accumulated by the current integration method can be eliminated and hence, the accuracy in the estimation of the SOC can be maintained.

In the configuration of this embodiment, when the duration Ts is less than a threshold D, a command value of a charge voltage Vc is not increased. In the configuration of this embodiment, in a case where a charge current Ic temporarily becomes smaller than a predetermined value Ib1 by being influenced by an error in the current measurement or noise, it is possible to suppress the increase of a command value of a charge voltage Vc.

In the configuration of this embodiment, a command value of a charge voltage Vc is transmitted from the control device 120 to the vehicle ECU 40, and the vehicle ECU 40 that has received the command value adjusts a charge voltage Vc. That is, a charge voltage Vc of the secondary battery cell 62 can be controlled by a cooperative operation of the control device 120 and the vehicle ECU 40. Such a configuration has an advantageous effect with respect to a point that the present technique of this embodiment is applicable to a charging system where a charge control function of the battery 50 can be shared by “the control device 120 of the energy storage apparatus” and “the external charge control device (vehicle ECU 40)”.

### OTHER EMBODIMENTS

The present invention is not limited to the embodiments described with reference to the above description and drawings. For example, the following embodiments are also included in the technical scope of the present invention.
(1) In the embodiment, the secondary battery cell having the low change regions L and the high change regions H in the SOC-OCV characteristic is illustrated as an example of the energy storage cell. The secondary battery cell is not necessarily required to have a characteristic having two change regions. The secondary battery cell may have only one change region. The energy storage cell may be a capacitor or the like. The energy storage cell is not limited to a plurality of cells, and may be a single cell. A plurality of cells may be connected in series and in parallel.
(2) In the embodiment, an example where the battery 50 is applied to the automobile is described. Besides the above example, the present invention can also be used for motorcycles and railroads. The usage and the applications of the battery 50 are not limited to its use for a moving body such as an automobile. It can also be used as a stationary energy storage apparatus such as an energy storage apparatus for an uninterruptible power system or an energy storage apparatus for a power generating system.
(3) In the embodiment, a command value of a charge voltage Vc is calculated by the management device 100 of the battery 50. The command value of the charge voltage Vc may be determined by the vehicle ECU 40. For example, the management device 100 may notify only information on the SOC to the vehicle ECU 40, and the vehicle ECU 40 may determine a command value of a charge voltage Vc by looking up the look-up table (FIG. 8) of the charge voltage Vc. The same goes for a control of increasing the charge voltage Vc.
(4) In the embodiment, a command value of a charge voltage is increased when the determination is YES in all three steps consisting of S31, S33, and S40. The processing in steps S31 and S40 may not be performed, and only the processing in S33 may be performed. When the determination in step S33 is YES, a command value of a charge voltage may be increased.
(5) In this embodiment, in a case where a duration Ts of a state that a charge current Ic is smaller than a predetermined value Ib1 is equal to or more than a threshold D, a command value of a charge voltage Vc is increased. In a case where a charge current Ic falls below a predetermined value Ib1, a command value of a charge voltage Vc may be immediately increased.
(6) In the embodiment, it is determined whether a charge current Ic is smaller than a predetermined value Ib1 by comparing the charge current Ic with the range B. It is determined whether a charge current Ic is smaller than a predetermined value Ib1 by obtaining a difference between the charge current Ic and the predetermined value Ib1. When the difference between the charge current Ic and an expected value Ic0 does not fall within an allowable range, it may be determined that the charge current Ic is smaller than the predetermined value Ib1.
(7) A look-up table of a charge voltage Vc may be provided for each temperature of the battery 50. A command value of a charge voltage Vc may be determined by selecting a look-up table to be used based on information of a temperature of the battery 50. A charge voltage curve Yc may be stored in the memory 123 without using the look-up table, and a command value of a charge voltage Vc may be determined by referring to the charge voltage curve Yc.
(8) In this embodiment, a control cycle of a charge voltage Vc is set equal to a measurement cycle N of the battery 50. The control cycle of the charge voltage Vc may be different from the measurement cycle N of the battery 50. For example, the control cycle of the charge voltage Vc may be about 10 times as long as the measurement cycle of the battery 50.
(9) In the embodiment, the resetting of the increase of a command value of a charge voltage Vc (S70) is performed using the mode transition of the management device 100 as a trigger signal. The resetting of the command value may be performed using other signals as the trigger signal. For example, in a case where a full charge request signal is outputted from the management device 100 to the vehicle ECU 40, the increase of the command value of the charge voltage Vc may be reset using the full charge request signal as a trigger.
(10) In the embodiment, in both the low change regions L and the high change regions H, a charge current Ic of the battery 50 is compared with a predetermined value Ib1, and when the charge current Ic is smaller than the predetermined value Ib1, the command value of the charge voltage Vc is increased. Out of the low change regions L and the high change regions H, at least in the high change regions H, a charge current Ic may be compared with a predetermined value Ib1, and when the charge current Ic is smaller than the predetermined value, the command value of the charge voltage Vc may be increased. That is, the processing of increasing a command value of a charge voltage Vc may be performed or may not be performed in the low change regions L as long as the processing is performed in the high change regions. Whether the secondary battery cell is included in the high change region or in the low change region can be determined based on an SOC obtained by a current integration method.
(11) In the embodiment, an example where the battery 50 is charged to a fully charged state has been described. A target SOC of charging is not limited to a fully charged state (SOC=100 [%]), and may be states other than the fully charged such as, such as a charged state of 80% and a charged state of 90%. In addition, charging may be performed in the plateau region.
(12) In the embodiment, the battery 50 is charged with electricity outputted from the generator 30. The charging of the battery 50 is not limited to electricity outputted from the generator 30. The battery 50 may be charged by electricity outputted from a battery charger or a power converter (for example, a converter) or the like. That is, the power device that charges the battery 50 that is an energy storage apparatus is not limited to the generator 30, and may be a battery charger or a power converter.
(13) In the embodiment, an SOC [%] of the secondary battery cell 62 is calculated by a current integration method, and a command value of a charge voltage Vc of the secondary battery cell 62 is determined based on the SOC [%] obtained by the current integration method. A remaining charge [Ah] of the secondary battery cell 62 may be calculated by a current integration method, and a command value of a charge voltage Vc of the secondary battery cell 62 may be determined based on the remaining charge [Ah] obtained by the current integration method. In this case, a “remaining charge-OCV correlation characteristic” can be used instead of the “SOC-OCV correlation characteristic”, and a “remaining charge-Vcs charge voltage curve” can be used instead of the “SOC-Vcs charge voltage curve”. In the embodiment, the example where the charging is performed to a fully charged state and an SOC is corrected has been described. However, it is also possible to perform the processing where the charging is performed to a fully charged state and a remaining charge Cr is corrected.

Cr=Cro+(∫Idt) (6)
Cr: remaining charge, Cro: initial value of remaining charge, I: current

1. A control device for an energy storage cell, wherein the control device calculates an SOC or a remaining charge of the energy storage cell by a current integration method, and the control device determines a command value of a charge voltage for the energy storage cell based on the SOC or the remaining charge obtained by the current integration method.

2. The control device for an energy storage cell according to claim 1, wherein the control device increases a command value of a charge voltage when a charge current of the energy storage cell is smaller than a predetermined value.

3. The control device for an energy storage cell according to claim 2, wherein the control device does not increase the command value of the charge voltage when a duration in a state where the charge current is smaller than the predetermined value is less than a threshold.

4. The control device for an energy storage cell according to claim 1, wherein the control device corrects an SOC or a remaining charge calculated by a current integration method to the SOC or the remaining charge when the energy storage cell is charged to a fully charged state.

5. An energy storage apparatus comprising:
an energy storage cell; and
the control device according to claim 1,
wherein the control device transmits the command value of the charge voltage to an external charge control device that controls the charge voltage for the energy storage apparatus.

6. The energy storage apparatus according to claim 5, wherein
the energy storage cell is a secondary battery cell that has a low change region where a change amount of an OCV with respect to a change amount of an SOC is relatively low and a high change region where the change amount of the OCV with respect to the change amount of the SOC is relatively high in an SOC-OCV characteristic, or a secondary battery cell that has a low change region where a change amount of the OCV with respect to a change amount of a remaining charge is relatively low and a high change region where the change amount of the OCV with respect to the change amount of the remaining charge is relatively high in a remaining charge-OCV characteristic, and
the control device compares a charge current of the energy storage cell with a predetermined value, and increases a command value of a charge voltage when the charge current of the energy storage cell is smaller than a predetermined value at least in the high change region.

7. The energy storage apparatus according to claim 6, wherein the control device compares a charge current of the energy storage cell with a predetermined value, and increases a command value of the charge voltage when the charge current of the energy storage cell is smaller than the predetermined value in both the low change region and the high change region.

8. A charging system comprising:
a power device that outputs electric power;
an energy storage apparatus that is connected to the power device; and
a charge control device that controls an output of the power device, wherein
the energy storage apparatus includes:
an energy storage cell; and
the control device according to claim 1,
the control device:
calculates an SOC or a remaining charge of the energy storage cell by a current integration method;
determines a command value of a charge voltage based on the calculated SOC or the calculated remaining charge; and
transmits the determined command of the charge voltage to the charge control device; and
the charge control device charges the energy storage cell by controlling an output voltage of the power device to a command value received from the control device.

9. The charging system according to claim 8, wherein
the charge control device charges the energy storage cell to a fully charged state, and
the control device corrects an SOC or a remaining charge calculated by a current integration method to the SOC or the remaining charge when the energy storage cell is charged to a fully charged state.

10. A method for controlling a charge voltage, wherein a command value of a charge voltage is determined based on an SOC or a remaining charge obtained by a current integration method of an energy storage cell.
